(19) United States
(12) Patent Application Publication
(10) Pub. No.: US 2007/0040837 A1
(43) Pub. Date: Feb. 22, 2007

(54) Motion vector estimation method and continuous picture generation method based on convexity property of sub pixel

(76) Inventors: Jin Wuk Seok, Daejeon-city (KR); Pyeong Soo Mah, Daejeon-city (KR); Bum Ho Kim, Daejeon-city (KR); Hyung Kook Jun, Seoul (KR); Jeong Woo Lee, Daejeon-city (KR)

Correspondence Address: LADAS & PARRY LLP, 224 SOUTH MICHIGAN AVENUE, SUITE 1600, CHICAGO, IL, 60604, US

(21) Appl. No.: 11/501,980

(22) Filed: Aug. 10, 2006

(30) Foreign Application Priority Data
Aug. 19, 2005 (KR) 10-2005-0076456
Dec. 15, 2005 (KR) 10-2005-0124050

(51) Int. Cl. G06T 15/70

(52) U.S. Cl. 345/474

(57) ABSTRACT

A motion vector estimation method and continuous discrete image generation method based on a convexity property of a sub-pixel are provided. The method of estimating a motion vector includes: generating an objective function for a differential definition of a sub-pixel system composed of a chain of arbitrary n-tap filters with respect to an arbitrary k-th order sub-pixel, based on the relation between an integer pixel and a sub-pixel generated through linear FIR filtering; and estimating a motion vector of a sub-pixel by applying a conjugated quadratic algorithm to the objective function.

### CROSS-REFERENCE TO RELATED PATENT APPLICATIONS

This application claims the benefits of Korean Patent Application No. 10-2005-0076456, filed on Aug. 19, 2005, and Korean Patent Application No. 10-2005-0124050, filed on Dec. 15, 2005, in the Korean Intellectual Property Office, the disclosures of which are incorporated herein in their entireties by reference.

### BACKGROUND OF THE INVENTION

1. Field of the Invention

The present invention relates to a method of minimizing prediction calculation of a sub-pixel motion vector and an integer motion vector with avoiding degradation of picture quality when moving pictures are encoded, and more particularly, to a method of estimating a sub-pixel and an integer pixel through a conjugate quadratic function by using the convexity property of a sub-pixel in a moving picture encoder, and a method of estimating a discrete image as a continuous image.

2. Description of the Related Art

The amount of digital image data that is used in video conference, high picture quality televisions, video on demand (VOD) receivers, personal computers (PCs) supporting moving picture experts group (MPEG) images, game consoles, ground-wave digital broadcasting receivers, digital satellite broadcasting receivers, and cable TVs, increases greatly in the process of digitizing an analog signal and due to the characteristic of an image itself. Accordingly, the digital image data is not used as it is, but is compressed through an effective compression method and then used.

The compression of the digital image data can be broken down into three types: a method reducing temporal redundancy, a method reducing spatial redundancy, and a method reducing the amount of data using the statistical characteristic of generated codes. Among these, a representative one of the method of reducing temporal redundancy is a motion estimation and compensation method and is used by most of moving picture compression standard drafts, such as the MPEG and H.263.

In the motion estimation and compensation method, a part most similar to a predetermined part of a current image is found in the previous or next reference image and only the difference component of the two parts is transmitted. If a motion vector is found as precisely as possible, the difference component to be transmitted is reduced and the amount of the data can be reduced more effectively. However, a lot of estimation time and computation amount are required in order to find a most similar part in the previous or next image. Accordingly, efforts have been being made continuously to reduce a motion estimation time that takes the largest part of a time for encoding moving pictures.

Meanwhile, the motion estimation method includes a method on a pixel-by-pixel basis and a method on a block-by-block basis. Between the two, the block-based method is the most widely used one.

In the block-based estimation method, an image is divided into blocks of a predetermined size, and a block best matching a block of a current image is found in a search area of the previous image. The difference between the found block and the current image block is referred to as a motion vector. In the block-based estimation method, the motion vector is encoded and processed. For the matching calculation between two blocks, a variety of matching functions can be used. The most widely used one is a sum of absolute difference (SAD) that is a value obtained by adding all the absolute values of differences between pixels of the two blocks.

In the case of H.264 codec, a searching operation is performed by using a cost function based on a rate distortion optimization (RDO), instead of using the convention SAD-focused searching method. The cost function used in H.264 performs a search operation using a rate-distortion cost that is obtained by adding the conventional SAD value to a value obtained by multiplying the number of encoded coefficients by a Lagrangian. At this time, the number of the encoded coefficient is determined through substitution with a value in proportion to a quantization coefficient value, and the result is multiplied by a fixed Lagrangian multiplier, a cost value is determined and a search operation is performed.

Also, in the H.264 moving picture encoding, in order to achieve both a high compression efficiency and picture quality, a total of 8 different blocking modes are used to select one mode having a minimum value among the blocks, unlike the conventional moving picture encoding in which encoding is performed in units of 16:16 large blocks or 8:8 large blocks.

Also, in the H.264 moving picture encoding standard, a sub-pixel is generated as down to a ¼ pixel as well as a ½ pixel and with the sub-pixels, moving picture encoding is performed. Accordingly, an encoding object image that has a pixel area four times bigger than an integer pixel should be generated and at the same time even estimation of a sub-pixel should be performed. As a result, the amount of computation is much more than that of the previous methods, and it is needed to reduce the amount of the image estimation and motion estimation computation.

### SUMMARY OF THE INVENTION

The present invention provides a method estimation method greatly reducing operations for estimating a sub-pixel by using the characteristic of the sub-pixel, and a method of generating a discrete image as a continuous image.

According to an aspect of the present invention, there is provided a motion estimation method for encoding moving pictures, the method including: generating an objective function for a differential definition of a sub-pixel system composed of a chain of arbitrary n-tap filters with respect to an arbitrary k-th order sub-pixel, based on the relation between an integer pixel and a sub-pixel generated through linear FIR filtering; and estimating a motion vector of a sub-pixel by applying a conjugated quadratic algorithm to the objective function.

According to another aspect of the present invention, there is provided a method of generating a discrete image as a continuous image, the method including: function for a differential definition of a sub-pixel system composed of a chain of arbitrary n-tap filters with respect to an arbitrary k-th order sub-pixel, based on the relation between an integer pixel and a sub-pixel generated through linear FIR filtering; and generating a discrete image of the n-tap FIR filter sub-pixel system as a continuous image, by expanding a Taylor series in relation to the value of an objective function with respect to the arbitrary k-th order sub-pixel.

The method of conjugated polynomial search method using the convexity property of a sub-pixel and the method of generating a discrete image as a continuous image according to the present invention, the characteristic of a sub-pixel image is analyzed and through the characteristic of three sub-pixel images derived from the analysis and a differential definition, an integer pixel, a sub-pixel and a continuous image of a discrete image are efficiently estimated.

### BRIEF DESCRIPTION OF THE DRAWINGS

The above and other features and advantages of the present invention will become more apparent by describing in detail exemplary embodiments thereof with reference to the attached drawings in which:

FIG. 1 is a block diagram of a structure of a conventional moving picture encoder to which a method according to an embodiment of the present invention is applied;

FIG. 2 illustrates interpolation of an integer pixel and a sub-pixel by a sub-pixel system when a finite impulse response (FIR) filter coefficient is ½ according to an embodiment of the present invention;

FIG. 3 illustrates interpolation of an integer pixel and a sub-pixel by a sub-pixel system with a variable FIR coefficient according to an embodiment of the present invention;

FIG. 4 is a conceptual diagram of a method of searching for a sub-pixel according to an embodiment of the present invention; and

FIG. 5 illustrates a method of predicting an integer pixel according to an embodiment of the present invention.

### DETAILED DESCRIPTION OF THE INVENTION

The present invention will now be described more fully with reference to the accompanying drawings, in which exemplary embodiments of the invention are shown.

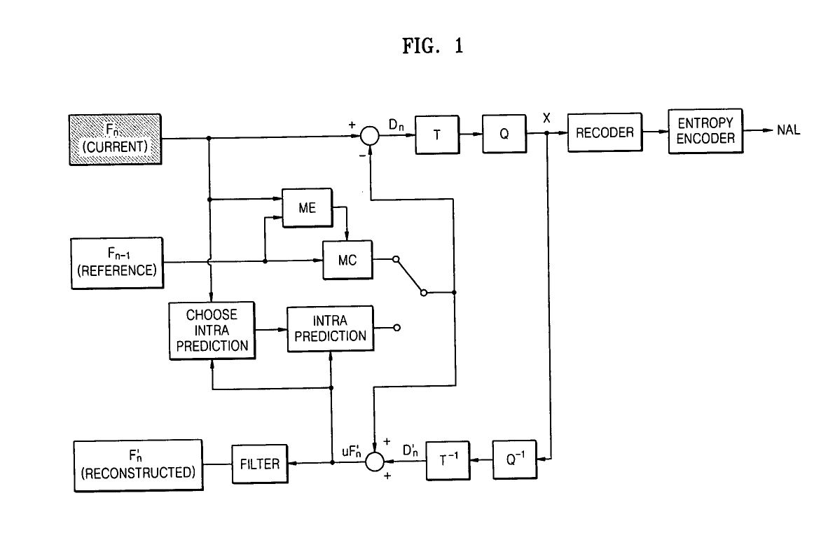

FIG. 1 is a block diagram of an H.264 moving picture encoder to which a method according to an embodiment of the present invention is applied.

Referring to FIG. 1, the motion estimator is composed of an integer pixel estimator estimating a motion vector in units of integer pixels, and a sub-pixel estimator estimating a motion vector in units of optimum sub-pixels and ¼ pixels based on the found motion vector of the integer pixel.

The present invention is not limited to the H.264 application but can also be applied to all video images. The H.264 is only an example of the applications. The integer pixel estimator estimates a motion vector by performing integer pixel prediction and sub-pixel prediction on a block-by-block basis.

A method of conjugated polynomial search using the convexity of a sub-pixel and an algorithm for generating a discrete image as a continuous image will now be explained. In order to help understanding of the present invention, the difference between the conventional technology and the present invention will be explained first.

In the estimation of an integer pixel and a sub-pixel according to the conventional technology, first, a sub-pixel image that is the object of estimation is generated in relation to an entire image unit at maximum, or in relation to each estimation object window region for estimating a motion. Then, through an estimation pattern based on block estimation, an integer pixel and a sub-pixel are estimated.

Meanwhile, in the present invention, through an RD-cost value in relation to neighboring integer pixels generated after first integer pixel estimation is finished, estimation of a sub-pixel is performed. If it is determined that estimation of a next integer pixel is needed in the process of estimating the first integer pixel, an estimation position of the next integer pixel is predicted through an RD-cost value generated by the estimation of the first integer pixel. After the integer pixel is estimated through the RD-cost value, a sub-pixel is estimated by using only the integer pixel RD-cost value without separately estimating a sub-pixel.

The principle of the present invention will now be explained with reference to mathematical expressions. Generally, estimation of a sub-pixel is performed through a finite impulse response (FIR) filtering of integer pixels. This will be explained briefly now.

First, it is assumed that P(x,y,t) indicates an integer pixel value of an image at coordinates (x,y) at time t. Here, for convenience of explanation, assuming that time t is all fixed as a current time, and any one axis of coordinates (x, y) is fixed, an integer pixel at an arbitrary position can be expressed as P(x₀+s₀h). Here, x₀ indicates initial coordinates; h indicates a unit variation of an integer pixel and is usually 1; and s₀ is a proportional value in relation to the unit variation and is a scale parameter to indicate an arbitrary position with respect to x₀.

In this case, generation of a half pixel used in most of moving picture codecs is expressed as the following expression 1:

$$P ( {x}_{0} + {s}_{1} ( \frac{1}{2} ) h ) = {\sum }_{{s}_{0}} ( δ ( \frac{1}{2} {s}_{1} - {s}_{0} ) + {F}_{0} ( \frac{1}{2} ( {s}_{1} - 1 ) - {s}_{0} ) ) P ( {x}_{0} + {s}_{0} h ) \qquad ( 1 )$$

In equation 1, δ(x) denotes a Dirac-Delta function, and if x is 0, it is 1 or else, it is 0. F₀(s-k) is a 0-th FIR filter coefficient, and only when (s-k) is an integer and in a predetermined range, F₀(s-k) has a value.

Generally, in case of the MPEG-2 or H.261, F₀(s-k) has a value as the following equation 2:

$${F}_{0} ( x ) = \{ \begin{matrix}0 & \frac{1}{2} \\ 1 & \frac{1}{2} \\ otherwise & 0\end{matrix} \qquad ( 2 )$$

Meanwhile, in case of H.264, F₀(s-k) has a value as the following equation 3:

$${F}_{0} ( x ) = \{ \begin{matrix}- 3 & \frac{1}{32} \\ - 2 & \frac{- 5}{32} \\ - 1 & \frac{20}{32} \\ 0 & \frac{20}{32} \\ 1 & \frac{- 5}{32} \\ 2 & \frac{1}{32} \\ otherwise & 0\end{matrix} \qquad ( 3 )$$

By generalizing this and determining as an arbitrary k-th order sub-pixel, the can be expressed as the following equation 4:

$$P ( {x}_{0} + {s}_{1} ( \frac{1}{2} ) h ) = {\sum }_{{s}_{0}} ( δ ( \frac{1}{2} {s}_{1} - {s}_{0} ) + {F}_{0} ( \frac{1}{2} ( {s}_{1} - 1 ) - {s}_{0} ) ) P ( {x}_{0} + {s}_{0} h ) \\ P ( {x}_{0} + {{s}_{2} ( \frac{1}{2} )}^{2} h ) = {\sum }_{{s}_{1}} ( δ ( \frac{1}{2} {s}_{2} - {s}_{1} ) + {F}_{1} ( \frac{1}{2} ( {s}_{2} - 1 ) - {s}_{1} ) ) P ( {x}_{0} + {s}_{1} ( \frac{1}{2} ) h ) \\ \begin{matrix}… & …\end{matrix} \\ P ( {x}_{0} + {{s}_{k} ( \frac{1}{2} )}^{k} k ) = {\sum }_{{s}_{k}} ( δ ( \frac{1}{2} {s}_{k} - {s}_{k - 1} ) + {F}_{k - 1} ( \frac{1}{2} ( {s}_{k} - 1 ) - {s}_{k - 1} ) ) P ( {x}_{0} + {{s}_{k - 1} ( \frac{1}{2} )}^{k - 1} h ) \qquad ( 4 )$$

If a ¼ pixel, that is, a second-order sub-pixel is expressed as an integer pixel as used in H.264, it can be expressed as the following equation 5:

$$\begin{matrix}P ( {x}_{0} + {{s}_{2} ( \frac{1}{2} )}^{2} h ) = {\sum }_{{s}_{1}} ( δ ( \frac{1}{2} {s}_{1} - {s}_{1} ) + {F}_{1} ( \frac{1}{2} ( {s}_{2} - 1 ) - {s}_{1} ) ) \cdot \\ {\sum }_{{s}_{0}} ( δ ( \frac{1}{2} {s}_{1} - {s}_{0} ) + {F}_{0} ( \frac{1}{2} ( {s}_{1} - 1 ) - {s}_{0} ) ) \\ P ( {x}_{0} + {s}_{0} h ) \\ = {\sum }_{{s}_{1}} {\sum }_{{s}_{0}} ( δ ( \frac{1}{2} {s}_{2} - {s}_{1} ) + {F}_{1} ( \frac{1}{2} ( {s}_{2} - 1 ) - {s}_{1} ) ) \cdot \\ ( δ ( \frac{1}{2} {s}_{1} - {s}_{0} ) + {F}_{0} ( \frac{1}{2} ( {s}_{1} - 1 ) - {s}_{0} ) ) \\ P ( {x}_{0} + {s}_{0} h ) \\ = {\sum }_{{s}_{1}} {\sum }_{{s}_{0}} {\prod }_{n = 0}^{1} ( \text{(} δ ( \frac{1}{2} {s}_{n + 1} - {s}_{n} ) + {F}_{ n} ( \frac{1}{ 2} ( {s}_{ n + 1} - 1 ) - {s}_{ 0} ) ) \\ P ( {x}_{0} + {s}_{0} h )\end{matrix} \qquad ( 5 )$$

If this is expanded to a general k-th sub-pixel, it can be expressed as the following equation 6:

$$P ( {x}_{0} + {{s}_{k} ( \frac{1}{2} )}^{k} h ) = {\sum }_{{s}_{k - 1} , {s}_{k - 2} … {s}_{0}} {\prod }_{n = 0}^{k - 1} ( δ ( \frac{1}{2} {s}_{n + 1} - {s}_{n} ) + {F}_{n} ( \frac{1}{2} ( {s}_{n + 1} - 1 ) - {s}_{n} ) ) P ( {x}_{0} + {s}_{0} h ) \qquad ( 6 )$$

In order to express the relation between the arbitrary k-th order sub-pixel and an integer pixel shown as equation 6 in the form of a matrix, if the filter coefficient part of the right side is unified, it can be expressed as the following equation 7:

$$\begin{matrix}P ( {x}_{0} + {s}_{1} ( \frac{1}{2} ) h ) = {\sum }_{{s}_{0}} ( δ ( \frac{1}{2} {s}_{1} - {s}_{0} ) + {F}_{0} ( \frac{1}{2} ( {s}_{1} - 1 ) - {s}_{0} ) ) \\ P ( {x}_{0} + {s}_{0} h ) \\ = {\sum }_{{s}_{0}} \overline{F} ( \vert \frac{1}{2} {s}_{1} - {s}_{0} \vert < λ ) P ( {x}_{0} + {s}_{0} h )\end{matrix} \qquad ( 7 )$$

Here,

$$\overline{F} ( \vert \frac{1}{2} {s}_{1} - {s}_{0} \vert < λ )$$

of equation 7 is defined as the following equation 8:

$$\overline{F} ( \vert \frac{1}{2} {s}_{1} - {s}_{0} \vert < λ ) = \{ \begin{matrix}1 & \vert \frac{1}{2} {s}_{1} - {s}_{0} \vert = 0 \\ {α}_{f ( {s}_{0} - \frac{1}{2} {s}_{1} )} & \vert \frac{1}{2} {s}_{1} - {s}_{0} \vert < λ and \vert \frac{1}{2} {s}_{1} - {s}_{0} \vert \neq 0 \\ 0 & \vert \frac{1}{2} {s}_{1} - {s}_{0} \vert > λ\end{matrix} \qquad ( 8 )$$

In equation 8, subscript f(x) is defined as the following equation 9:

The form of equation 7 defined in relation to a first-order sub-pixel is transformed into a determinant as the following equation 10:

$$\begin{matrix}P ( {x}_{0} + {s}_{1} ( \frac{1}{2} ) h ) = {\sum }_{\vert \frac{1}{2} {s}_{1} - {s}_{0} \vert < λ} \overline{F} ( \vert \frac{1}{2} {s}_{1} - {s}_{0} \vert < λ ) P ( {x}_{0} + {s}_{0} h ) \\ = \overline{F} P ( {x}_{0} , h )\end{matrix} \qquad ( 10 )$$

In equation 10, vector P(x₀,h) is defined as the following equation 11:
P(x₀, h)=( . . . , P(x₀−h), P(x₀), P(x₀+h), . . . )^{T}∈ [symbol] ^{∞} (11)

The notation used in equations 10 and 11 is expanded to its k-th order sub-pixel as the following equation 12:

$$P ( {x}_{0} + {s}_{1} ( \frac{1}{2} ) h ) = {\overline{F}}_{0} P ( {x}_{0} , h ) {\text{\vert}}_{{s}^{1} = {s}_{1}} \\ P ( {x}_{0} + {{s}_{2} ( \frac{1}{2} )}^{2} h ) = {\overline{F}}_{1} P ( {x}_{0} , ( \frac{1}{2} ) h ) {\vert}_{{s}^{2} = {s}_{2}} \\ = {\overline{F}}_{1} {\overline{F}}_{0} P ( {x}_{0} , ) {\text{\vert}}_{{s}^{2} = {s}_{2}} \\ \begin{matrix}… & …\end{matrix} \\ P ( {x}_{0} + {{s}_{k} ( \frac{1}{2} )}^{k} h ) = {\prod }_{n = 0}^{k - 1} {\overline{F}}_{n} P ( {x}_{0} , h ) {\vert}_{{s}^{k} = {s}_{k}} = {F}^{k} P ( {x}_{0} , h ) {\vert}_{{s}^{k} = {s}_{k}} \qquad ( 12 )$$

In equation 12, it is defined that

$${\prod }_{n = 0}^{k - 1} {\overline{F}}_{n} = {F}^{k} .$$

For convenience, equation 12 expressed in the form of a matrix can be transformed to a vector form. Assuming that vector f^{s}^{^{k}} ∈ F^{k} is an s^{k}-th column vector of matrix F^{k}, and a maximum subscript among elements of f^{s}^{^{k}} ∈ F^{k} is m, equation 12 can be defined as the following equation 13:

$$m = max f ( {s}_{0} - {( \frac{1}{2} )}^{k} {s}_{k} ) {\vert}_{\vert {( \frac{1}{2} )}^{k} - {s}_{0} \vert < λ} \qquad ( 13 )$$

Here, the integer pixel and vector in relation to an arbitrary k-th order sub-pixel can be expressed as the following equation 14:

$$P ( {x}_{0} + {{s}_{k} ( \frac{1}{2} )}^{k} h ) = f \cdot P ( {x}_{0} - mh ; {x}_{0} + mh ) \qquad ( 14 )$$

In order to define a differential at an arbitrary sub-pixel by using equation 12, the subscript at the k-th order sub-pixel is expressed as the following equation 15:

$$P ( {x}_{0} + {{s}_{k} ( \frac{1}{2} )}^{k} h ) = {F}^{k} P ( {x}_{0} , h ) {\vert}_{{s}^{k} = {s}_{k}} \\ P ( {x}_{0} + {s ( \frac{1}{2} )}^{k} h ) = {F}^{k} P ( {x}_{0} , h ) {\vert}_{{s}^{k} = s} \\ P ( {x}_{0} + {sh}^{k} ) = {F}^{k} P ( {x}_{0} , h ) {\vert}_{{s}^{k} = s} \qquad ( 15 )$$

If the k-th order sub-pixel is expressed as equation 15, an arbitrary k-th order sub-pixel and a reference sub-pixel (this may be an integer pixel) P(x₀) can be expressed in the form of a k-th order sub-pixel as the following equation 16:
P(x₀+h^{k})=F^{k}P(x₀, h)|ₛ_{^{k}}₌₁
P(x₀)=F^{k}P(x₀, h)|ₛ_{^{k}}₌₀ (16)

A differential of an arbitrary k-th order sub-pixel P(x₀) is defined by using equation 16, as the following equation 17:

$$\begin{matrix}dP ( {x}_{0} ) {\vert}_{x = {x}_{0}} = {lim}_{ {h}^{ k} -> 0} \frac{P ( {x}_{ 0} + {h}^{ k} )}{ {h}^{ k}} \\ = {lim}_{{h}^{k} -> 0} \frac{{F}^{k} P ( {x}_{0} h ) {\vert}_{{s}^{k} = 1} = {F}^{k} P ( {x}_{0} h ) {\vert}_{{s}^{k} = 0}}{{h}^{k}}\end{matrix} \qquad ( 17 )$$

If this is applied to an arbitrary k-th order sub-pixel system composed of a series of 2-tap FIR filters as shown in equation 2, the following equation 18 can be obtained:

$$\begin{matrix}P ( {x}_{ 0} + {h}^{ k} ) = P ( {x}_{0} ) + {h}^{k} \cdot \frac{1}{{h}^{k}} ( P ( {x}_{0} + {h}^{k} ) - P ( {x}_{0} ) ) \\ = P ( {x}_{0} ) + {h}^{k} \cdot \frac{1}{{h}^{k}} ( \frac{1}{2} P ( {x}_{0} ) + \frac{1}{2} P ( {x}_{0} + {h}^{k - 1} ) - P ( {x}_{0} ) ) \\ = P ( {x}_{0} ) + {h}^{k} \cdot \frac{1}{2 {h}^{k}} ( P ( {x}_{ 0} + {h}^{ k - 1} ) - P ( {x}_{ 0} ) ) \\ = P ( {x}_{0} ) + {h}^{k} \cdot \frac{1}{{h}^{k - 1}} \\ ( \frac{1}{ 2} P ( {x}_{ 0} ) + \frac{1}{ 2} P ( {x}_{ 0} + {h}^{ k - 2} ) - P ( {x}_{ 0} ) ) \\ = P ( {x}_{0} ) + {h}^{k} \cdot \frac{1}{2 {h}^{k - 1}} ( P ( {x}_{0} + {h}^{k - 2} ) - P ( {x}_{0} ) ) \\ = P ( {x}_{0} ) + {h}^{k} \cdot \frac{1}{{h}^{k - 2}} ( P ( {x}_{0} + {h}^{k - 2} ) - P ( {x}_{0} ) ) \\ = P ( {x}_{0} ) + {h}^{k} \cdot \frac{1}{{h}^{0}} ( P ( {x}_{ 0} + h60 ) - P ( {x}_{ 0} ) ) \\ = P ( {x}_{0} ) + {h}^{k} ( P ( {x}_{0} + h ) - P ( {x}_{0} ) )\end{matrix} \qquad ( 18 )$$

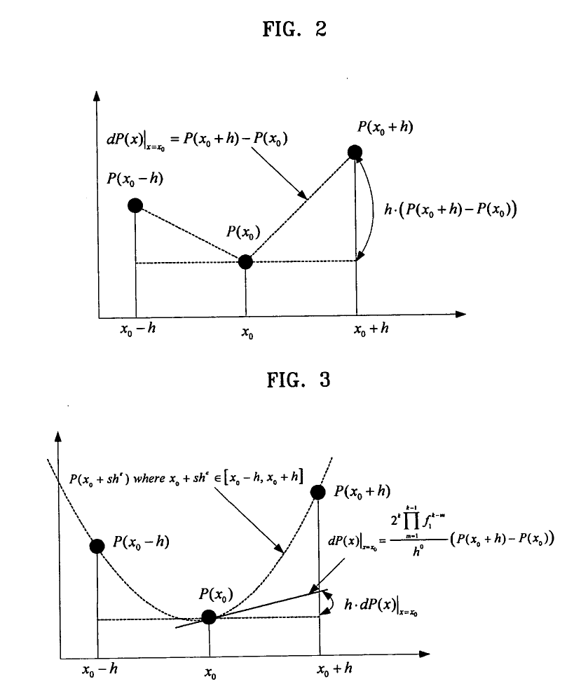

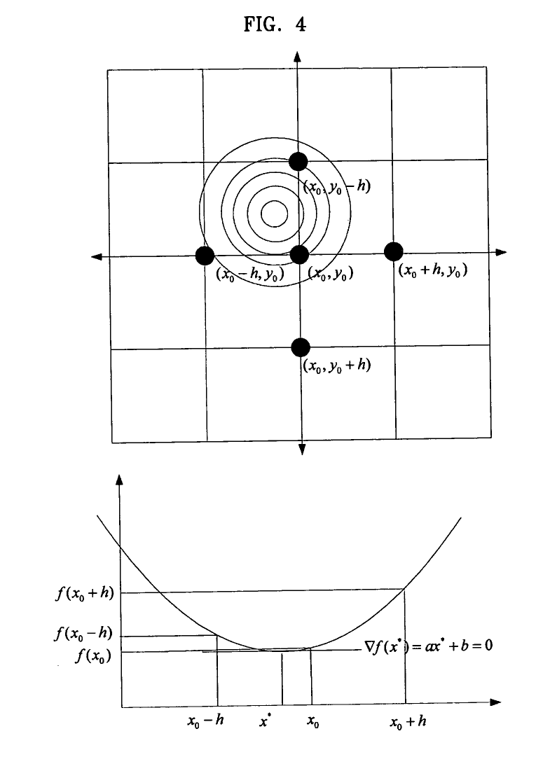

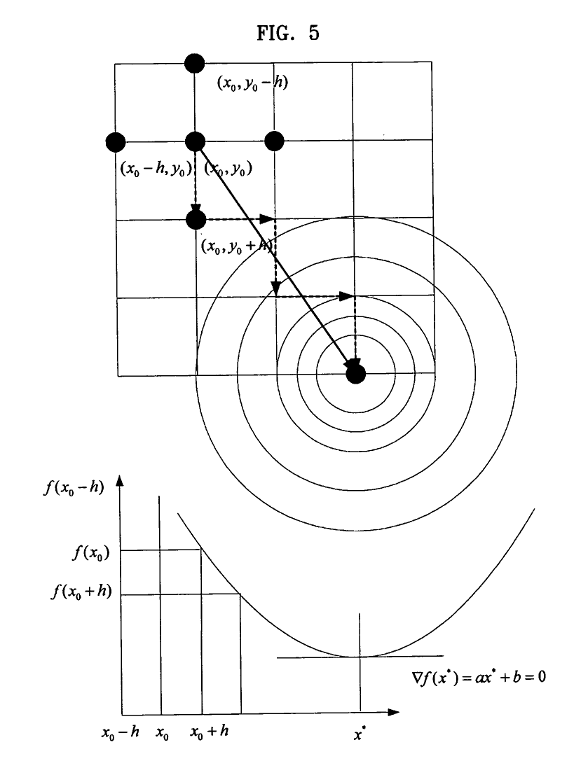

If equation 18 is substituted in equation 17, a differential is derived as the following equation 19 and the concept of the differential can be understood referring to FIG. 2:

$$\begin{matrix}\frac{ⅆ P ( x )}{ⅆ x} {\vert}_{x = {x}_{0}} = {lim}_{ {h}^{ k} -> 0} ( P ( {x}_{ 0} + {h}^{ k} ) - P ( {x}_{0} ) ) \\ = {lim}_{ {h}^{ k} -> 0} \frac{{h}^{k}}{{h}^{k}} ( P ( {x}_{0} + h ) - P ( {x}_{0} ) ) \\ = P ( {x}_{0} + h ) - P ( {x}_{0} )\end{matrix} \qquad ( 19 )$$

In order to apply an example of a 2-tap filter to an encoding system composed of a series of arbitrary n-tap FIR filters, if fₛ_{ₖ₋ₘ}^{k-m} is put as a 0-th row matrix element of F^{k-m} and as a column matrix element of Sₖ₋ₘ, the following equation 20 is assumed in order to define a differential in a sub-pixel system composed of a series of arbitrary n-tap FIR filters:
∀k ∈⁺ and s ∈, ∃κ>0, such that |P(x₀+sh^{k})−P(x₀)|<κ (20)

If a differential is derived from sub-pixel system composed of a series of arbitrary n-tap FIR filters by using equation 20, the following equation 21 is obtained:

$$\begin{matrix}P ( {x}_{0} + {h}^{k} ) = P ( {x}_{0} ) + {h}^{k} \cdot \frac{1}{{h}^{k}} ( P ( {x}_{0} + {h}^{k} ) - P ( {x}_{0} ) ) \\ = P ( {x}_{0} ) + {h}^{k} \cdot \frac{1}{{h}^{k}} \\ ( {\sum }_{{s}_{k - 1}} {f}_{{s}_{k - 1}}^{k - 1} \cdot P ( {x}_{0} + {s}_{k - 1} {h}^{k - 1} ) - P ( {x}_{0} ) ) \\ = P ( {x}_{0} ) + {h}^{k} \cdot \frac{1}{{h}^{k}} \\ ( {\sum }_{{s}_{k - 1}} {f}_{{s}_{k - 1}}^{k - 1} \cdot P ( {x}_{0} + {s}_{k - 1} {h}^{k - 1} ) - P ( {x}_{0} ) {\sum }_{n} {f}_{n}^{k - 1} ) \\ = P ( {x}_{0} ) + {h}^{k} \cdot \frac{1}{{h}^{k}} \\ ( {\sum }_{{s}_{k - 1}} {f}_{{s}_{k - 1}}^{k - 1} \cdot P ( {x}_{0} + {s}_{k - 1} {h}^{k - 1} ) - {\sum }_{n} {f}_{n}^{k - 1} P ( {x}_{0} ) ) \\ = P ( {x}_{ 0} ) + {h}^{ k} \cdot \frac{1}{ {h}^{ k}} \\ ( {\sum }_{{s}_{k - 1}} {f}_{{s}_{k - 1}}^{k - 1} \cdot ( P ( {x}_{0} + {s}_{k - 1} {h}^{k - 1} ) - P ( {x}_{0} ) ) ) \\ = P ( {x}_{0} ) + {h}^{k} \cdot \frac{1}{{h}^{k}} \\ ( {f}_{1}^{k - 1} \cdot ( P ( {x}_{0} + {h}^{k - 1} ) - P ( {x}_{0} ) ) ) + \\ {\sum }_{{s}_{k - 1} \cdot {s}_{k - 1} = 1} {f}_{{s}_{k - 1}}^{k - 1} \cdot ( P ( {x}_{0} + {s}_{k - 1} {h}^{k - 1} ) - P ( {x}_{0} ) ) \\ = P ( {x}_{0} ) + {h}^{k} \cdot \frac{2 {f}_{1}^{k - 1}}{{h}^{k - 1}} \\ ( {\sum }_{{s}_{k - 2}} {f}_{{s}_{k - 2}}^{k - 2} \cdot ( P ( {x}_{0} + {s}_{k - 2} {h}^{k - 2} ) - P ( {x}_{0} ) ) ) + \\ {\sum }_{{s}_{k - 1} \cdot {s}_{k - 1} = 1} {f}_{{s}_{k - 1}}^{k - 1} \cdot \\ ( {\sum }_{ {s}_{ k - 2}} {f}_{ {s}_{ k - 2}}^{ k - 1} \cdot ( P ( {x}_{ 0} + {s}_{ k - 2} \cdot {s}_{ k - 1} {h}^{ k - 2} ) - P ( {x}_{0} ) ) ) \\ = P ( {x}_{0} ) + {h}^{k} \cdot \frac{{2}^{2} {f}_{1}^{k - 1}}{{h}^{k - 2}} \\ ( {\sum }_{{s}_{k - 2}} {f}_{{s}_{k - 2}}^{k - 2} \cdot ( P ( {x}_{0} + {s}_{k - 2} {h}^{k - 2} ) - P ( {x}_{0} ) ) ) + \\ {\sum }_{{s}_{k - 1} \cdot {s}_{k - 1} = 1} {f}_{{s}_{k - 1}}^{k - 1} \cdot \\ ( {\sum }_{{s}_{k - 2}} {f}_{{s}_{k - 2}}^{k - 2} \cdot ( P ( {x}_{0} + {s}_{k - 2} \cdot {s}_{k - 1} {h}^{k - 2} ) - P ( {x}_{0} ) ) ) \\ = P ( {x}_{0} ) + {h}^{k} \cdot \frac{{2}^{2} {f}_{1}^{k - 1}}{{h}^{k - 2}} \\ ( {\sum }_{{s}_{k - 2}} {f}_{{s}_{k - 2}}^{k - 2} \cdot ( P ( {x}_{0} + {s}_{k - 2}^{} {h}^{k - 2} ) - P ( {x}_{0} ) ) ) + \\ {\sum }_{{s}_{k - 1} \cdot {s}_{k - 1} = 1} {f}_{{s}_{k - 1}}^{k - 1} \cdot \\ ( {\sum }_{{s}_{k - 2}} {f}_{{s}_{k - 2}}^{k - 2} \cdot ( P ( {x}_{0} + {s}_{k - 2} \cdot {s}_{k - 1} {h}^{k - 2} ) - P ( {x}_{0} ) ) ) \\ = P ( {x}_{0} ) + {h}^{k} \cdot \frac{{2}^{2} {f}_{1}^{k - 1} \cdot {f}_{1}^{k - 2}}{{h}^{k - 2}} \\ ( P ( {x}_{ 0} + {h}^{ k - 2} ) - P ( {x}_{ 0} ) ) + \\ {\sum }_{{s}_{k - 2} \cdot {s}_{k - 2} = 1} {\sum }_{{s}_{k - 1} \cdot {s}_{k - 1} = 1} {f}_{{s}_{k - 1}}^{k - 1} \cdot {f}_{{s}_{k - 2}}^{k - 2} \\ ( P ( {x}_{0} + {s}_{k - 2} \cdot {s}_{k - 1} {h}^{k - 2} ) - P ( {x}_{0} ) ) \\ … \\ = P ( {x}_{0} ) + {h}^{k} \cdot \frac{{2}^{k - 1} {\prod }_{m = 1}^{k - 1} {f}_{1}^{k - m}}{{h}^{0}} ( P ( {x}_{0} + h ) - P ( {x}_{0} ) ) + \\ {\sum }_{m = 1}^{k - 1} {\sum }_{{s}_{k - m} \cdot {s}_{k - m} = 1} {\prod }_{m} {f}_{{s}_{k - m}}^{k - m} \cdot \\ ( P ( {x}_{0} + {\prod }_{m} {s}_{k - m} {h}^{k - m} ) - P ( {x}_{0} ) )\end{matrix} \qquad ( 21 )$$

The second term of the right side of equation 21 can be expressed as the following equation 22:

$${\sum }_{m = 1}^{k - 1} {\sum }_{{s}_{k - m} \cdot {s}_{k - m} = 1} {\prod }_{m} {f}_{{s}_{k - m} }^{k - m} \cdot ( P ( {x}_{0} + {\prod }_{m} {s}_{k - m} {h}^{k - m} ) - P ( {x}_{0} ) ) \leq \frac{k ( k - 1 )}{2} {λκ ( {maxf}_{{s}_{k - m}}^{k - m} )}^{k - 1} < \frac{k ( k - 1 )}{2} {λκ ( \frac{1}{2} )}^{k - 1} \qquad ( 22 )$$

In equation 22, because of the assumption of equation 20 and that

$$k - m \neq 0 or 1 , \\ 0 < max {f}_{{s}_{k - m}}^{k - m} < \frac{1}{2} {f}_{1}^{k - m} < 1 ∀ k \cdot m ∈ {ℤ}^{+} .$$

Accordingly, in relation to k ↑ ∞, o(h^{ε}) that is o(h^{ε})↓0 exists, and equation 21 can be expressed as the following equation 23:

$$\begin{matrix}P ( {x}_{0} + {h}^{k} ) = P ( {x}_{0} ) + {h}^{k} \cdot \frac{{2}^{k - 1} {\prod }_{m = 1}^{k - 1} {f}_{1}^{k - m}}{{h}^{0}} \\ ( p ( {x}_{0} + h ) - P ( {x}_{0} ) ) + {\sum }_{m = 1}^{k - 1} {\sum }_{{s}_{k - m} , {s}_{k - m} \neq 1} \\ {\prod }_{m} {f}_{{s}_{k - m}}^{k - m} \cdot ( P ( {x}_{0} + {\prod }_{m} {s}_{k - m} {h}^{k - m} ) - P ( {x}_{0} ) ) \\ = P ( {x}_{0} ) + {h}^{k} \cdot \frac{{2}^{k - 1} {\prod }_{m = 1}^{k - 1} {f}_{1}^{k - m}}{{h}^{0}} \\ ( P ( {x}_{0} + h ) - P ( {x}_{0} ) ) + o ( {h}^{k} )\end{matrix} \qquad ( 23 )$$

According to equation 23, the differential in the sub-pixel system composed of a series of arbitrary n-tap FIR filters is as the following equation 24 and the differential concept can be shown referring to FIG. 3:

$$\begin{matrix}\frac{ⅆ P ( x )}{ⅆ x} {\vert}_{x = {x}_{ 0}} = {lim}_{{h}^{k} ↓ 0} \frac{P ( {x}_{0} + {h}^{k} ) - P ( {x}_{0} )}{{h}^{k}} \\ = {lim}_{{h}^{k} ↓ 0} \frac{1}{{h}^{k}} \\ ( {h}^{k} \cdot \frac{{2}^{k - 1} {\prod }_{m = 1}^{k - 1} {f}_{1}^{k - m}}{{h}^{0}} ( P ( {x}_{0} + h ) - P ( {x}_{0} ) ) + o ( {h}^{k} ) ) \\ = \frac{{2}^{k - 1} {\prod }_{m = 1}^{k - 1} {f}_{1}^{k - m}}{{h}^{0}} ( P ( {x}_{0} + h ) - P ( {x}_{0} ) )\end{matrix}$$

As the differential is derived from the sub-pixel system composed of a series of arbitrary n-tap FIR filters, if an objective function for estimating a sub-pixel is convex on a sub-pixel system and continuously second-order differentiable, and at the same time, the Hessian of the objective function is formed as a first order combination of a sub-pixel and is Lipschitz continuous, estimation can be performed by a conjugated quadratic algorithm.

First, it is assumed that objective function ƒ(x) ∈ C² for motion estimation is composed of a square of pixel differences between q blocks as the following equation 25:

$$f ( x ) = \frac{1}{2} {g}^{2} ( x , t ) = \frac{1}{2 N} {\sum }_{x = {x}_{0}}^{{x}_{0} + N} {( P ( x ; t ) - P ( x ; t - 1 ) )}^{2} \qquad ( 25 )$$

Here, objective function ƒ(x) ∈ C² is a convex function satisfying the following equation 26:
∀y=x₀+h^{ε}∈ [symbol] and s ∈[0,1], ƒ(x₀+s(y−x₀))=ƒ(x₀+sh^{ε})≦ƒ(x₀)+s(ƒ(x₀+h^{ε})−ƒ(x₀)) (26)

In order to prove equation 26, an objective function value at an arbitrary sub-pixel position x₀+sh^{ε}, is derived as the following equation 27:

$$\begin{matrix}f ( {x}_{0} + {sh}^{ɛ} ) = \frac{1}{2} {g}^{2} ( {x}_{0} + {sh}^{ɛ} , t ) \\ = \frac{1}{2 N} {\sum }_{x = {x}_{0}}^{{x}_{0} + N} {( P ( {x}_{0} + {sh}^{ɛ} ; t ) - P ( {x}_{0} + {sh}^{ɛ} ; t - 1 ) )}^{2} \\ = \frac{1}{2 N} {\sum }_{x = {x}_{0}}^{{x}_{0} + N} {( \begin{matrix}P ( {x}_{0} ; t ) + {sh}^{ɛ} \frac{\partial P ( x ; t )}{\partial x} {\vert}_{x = {x}_{0}} - \\ P ( {x}_{0} ; t - 1 ) 0 {sh}^{ɛ} \frac{\partial P ( x ; t - 1 )}{\partial x} {\vert}_{x = {x}_{0}}\end{matrix} )}^{2} \\ = \frac{1}{2 N} {\sum }_{x = {x}_{0}}^{{x}_{0} + N} ( \begin{matrix}P ( {x}_{0} ; t ) - P ( {x}_{0} ; t - 1 ) + {sh}^{ɛ} \\ \frac{\partial P ( x ; t )}{\partial x} {\vert}_{x = {x}_{0}} - \frac{\partial P ( x ; t - 1 )}{\partial x} {\vert}_{x = {x}_{0}}\end{matrix} ) \\ = \frac{1}{2 N} {\sum }_{x = {x}_{0}}^{{x}_{0} + N} ( \begin{matrix}{( P ( {x}_{0} ; t ) - P ( {x}_{0} ; t - 1 ) )}^{2} + \\ 2 {sh}^{ɛ} ( P ( {x}_{0} ; t ) - P ( {x}_{0} ; t - 1 ) ) \\ \frac{\partial P ( x ; t )}{\partial x} {\vert}_{x = {x}_{0}} - \frac{\partial P ( x ; t - 1 )}{\partial x} {\vert}_{x = {x}_{0}}\end{matrix} ) + \\ \frac{1}{2 N} {\sum }_{x = {x}_{0}}^{{x}_{0} + N} ( \begin{matrix}{( {sh}^{ɛ} )}^{2} \\ {( \frac{\partial P ( x ; t )}{\partial x} {\vert}_{x = {x}_{0}} - \frac{\partial P ( x ; t - 1 )}{\partial x} {\vert}_{x = {x}_{0}} )}^{2}\end{matrix} ) \\ = \frac{1}{2} {g}^{2} ( {x}_{0} , t ) + {sh}^{ɛ} \cdot g ( {x}_{0} , t ) \\ \frac{\partial g ( x )}{\partial x} {\vert}_{x = {x}_{0}} + \frac{1}{2} {( {sh}^{ɛ} )}^{2} \cdot {( \frac{\partial g ( x )}{\partial x} {\vert}_{x = {x}_{0}} )}^{2} \\ = \frac{1}{2} {( {g}^{2} ( {x}_{0} , t ) + {sh}^{ɛ} \cdot g ( {x}_{0} , t ) \frac{\partial g ( x )}{\partial x} {\vert}_{x = {x}_{0}} )}^{2}\end{matrix} \qquad ( 27 )$$

Here, since ƒ(x₀+h^{ε})=ƒ(x₀+sh^{ε})|ₛ₋₁, ƒ(x₀+h^{ε})−ƒ(x₀) is as the following equation 28:

$$\begin{matrix}f ( {x}_{0} + {h}^{ɛ} ) - f ( {x}_{0} ) = \frac{1}{2} {g}^{2} ( {x}_{0} ) + {h}^{ɛ} \cdot g ( {x}_{0} ) \cdot \frac{\partial g ( x ; t )}{\partial x} {\vert}_{x = {x}_{ 0}} + \\ \frac{1}{2} {( {h}^{ɛ} )}^{2} ( \frac{\partial g ( x ; t )}{\partial x} {\vert}_{x = {x}_{ 0}} ) - \frac{1}{2} {g}^{2} ( {x}_{0} ) \\ = {h}^{ɛ} \cdot g ( {x}_{0} ) \cdot \frac{\partial g ( x ; t )}{\partial x} {\vert}_{x = {x}_{ 0}} + \frac{1}{2} {( {h}^{ɛ} )}^{2} \\ {( \frac{\partial g ( x ; t )}{\partial x} {\vert}_{x = {x}_{ 0}} )}^{2}\end{matrix} \qquad ( 28 )$$

Through the results of equations 27 and 28, the following equation 29 is derived from the relation of equation 26:

Since the second term of the right side of equation 28 is a positive number according to the assumption of equation 26 and by raising the term to a higher power, and the first term is as equation 27, a conclusion of the following equation 30 is derived and the objective function is convex:
ƒ(x₀+sh^{ε})≦ƒ(x₀)+s·(ƒ(x₀+h^{ε})−ƒ(x₀)) (30)

Also, if an objective function is continuously second-order differentiable, the Hessian of the objective function is a positive definite, and is expressed as a square of a first order combination of an integer pixel as the following equation 31:

In providing equation 31, first, since the objective function is continuously second-order differentiable, the objective function satisfies the following equation 32 with respect to x ∈[x₀,x₀+h^{ε}]:

$$\begin{matrix}f ( {x}_{0} + {h}^{ɛ} ) - f ( {x}_{0} ) = \frac{\partial f ( x )}{\partial x} {\vert}_{x = {x}_{0}} \cdot {h}^{ɛ} + \\ {\int }_{0}^{1} ( 1 - s ) \cdot {( {h}^{ɛ} )}^{2} \cdot \frac{{\partial }^{2} f ( x )}{\partial {x}^{2}} ⅆ s \\ = \frac{\partial f ( x )}{\partial x} {\vert}_{x = {x}_{0}} \cdot {h}^{ɛ} + {( {h}^{ɛ} )}^{2} \\ {\int }_{0}^{1} ( 1 - s ) \cdot \frac{{\partial }^{2} f ( x )}{\partial {x}^{2}} ⅆ s\end{matrix} \qquad ( 32 )$$

Objective function ƒ(x) ∈ C² also satisfies the following equation 33 according to equation 28 derived from the convex condition and the definition of a continuous differential:

$$f ( {x}_{0} + {h}^{ɛ} ) - f ( {x}_{0} ) = {h}^{ɛ} \cdot g ( {x}_{0} ) \cdot \frac{\partial g ( x ; t )}{\partial x} {\vert}_{x = {x}_{0}} + \frac{1}{2} {( {h}^{ɛ} )}^{2} {( \frac{\partial g ( x ; t )}{\partial x} {\vert}_{x = {x}_{0}} )}^{2} \\ \frac{\partial f ( x )}{\partial x} {\vert}_{x = {x}_{0}} = \frac{\partial }{\partial x} ( \frac{1}{2} {g}^{2} ( {x}_{0} ) ) {\vert}_{x = {x}_{0}} = g ( {x}_{0} ) \cdot ( \frac{\partial g ( x ; t )}{\partial x} ) {\vert}_{x = {x}_{0}} \qquad ( 33 )$$

Accordingly, from equation 32, the following equation 34 can be derived:

$$\begin{matrix}\begin{matrix}f ( {x}_{ 0} + {h}^{ ɛ} ) - f ( {x}_{ 0} ) - \\ \frac{\partial f ( x )}{\partial x} {\vert}_{ x = {x}_{ 0}} \cdot {h}^{ ɛ}\end{matrix} = {h}^{ɛ} \cdot g ( {x}_{0} ) \cdot \frac{\partial g ( x ; t )}{\partial x} {\vert}_{x = {x}_{0}} + \\ \frac{1}{2} {( {h}^{ɛ} )}^{2} {( \frac{\partial g ( x ; t )}{\partial x} {\vert}_{x = {x}_{0}} )}^{2} - {h}^{ɛ} g ( {x}_{0} ) \cdot \\ \frac{\partial g ( x ; t )}{\partial x} {\vert}_{x = {x}_{ 0}} \\ = \frac{1}{2} {( {h}^{ɛ} )}^{2} {( \frac{\partial g ( x ; t )}{\partial x} {\vert}_{x = {x}_{0}} )}^{2}\end{matrix} \qquad ( 34 )$$

In the right side of equation 34, partial differential

$$\frac{\partial g ( x , t )}{\partial x} {\vert}_{x = {x}_{0}}$$

is expressed as the following equation 35:

$$\begin{matrix}\frac{\partial g ( x ; t )}{\partial x} {\vert}_{x = {x}_{ 0}} = \frac{\partial }{\partial x} \frac{1}{2 N} {\sum }_{x = {x}_{0}}^{{x}_{0} + N} ( P ( x ; t ) - P ( x ; t - 1 ) ) \\ = \frac{1}{2 N} {\sum }_{x = {x}_{0}}^{{x}_{0} + N} ( \frac{\partial P ( x ; t )}{\partial x} - \frac{\partial P ( x ; t - 1 )}{\partial x} ) \\ = \frac{1}{2 N} {\sum }_{s = 1}^{N} ( \begin{matrix}\frac{{2}^{k - 1} {\prod }_{m = 1}^{k - 1} {f}_{1}^{k - m}}{{h}^{0}} \\ ( \begin{matrix}( P ( {x}_{0} + nh \text{:} t ) - P ( {x}_{0} + ( n - 1 ) h \text{:} t ) ) - \\ ( \begin{matrix}P ( {x}_{0} + nh \text{:} t - 1 ) - \\ P ( {x}_{0} + ( n - 1 ) h \text{:} t - 1 )\end{matrix} )\end{matrix} )\end{matrix} ) \\ = \frac{1}{2 N} {\sum }_{g = 1}^{N} ( \begin{matrix}\frac{{2}^{k - 1} {\prod }_{m = 1}^{k - 1} {f}_{1}^{k - m}}{{h}^{0}} \\ ( \begin{matrix}( P ( {x}_{0} + nh \text{:} t ) - P ( {x}_{0} + nh \text{:} t - 1 ) ) - \\ ( \begin{matrix}P ( {x}_{0} + n - 1 ) h \text{:} t - \\ P ( {x}_{0} + ( n - 1 ) h \text{:} t - 1 )\end{matrix} )\end{matrix} )\end{matrix} ) \\ = \frac{1}{2 N} {\sum }_{x = {x}_{0}}^{{x}_{0} + N} ( \begin{matrix}\frac{ {2}^{ k - 1} {\prod }_{m = 1}^{ k - 1} {f}_{ 1}^{ k - m}}{ {h}^{ 0}} \\ ( \begin{matrix}( P ( x + h \text{:} t ) - P ( {x}_{0} + h \text{:} t - 1 ) ) - \\ ( P ( x \text{:} t ) - P ( x \text{:} t - 1 ) )\end{matrix} )\end{matrix} ) \\ = \frac{ {2}^{ k - 1} {\prod }_{m = 1}^{ k - 1} {f}_{ 1}^{ k - m}}{ {h}^{ 0}} ( g ( x + h ) - g ( x ) ) {\vert}_{x = {x}_{0}}\end{matrix} \qquad ( 35 )$$

In equation 35, partial differential

$$\frac{\partial g ( x , t )}{\partial x} {\vert}_{x = {x}_{0}}$$

is a first order combination of g(x), and also, g(x) is a first order combination of an integer pixel by definition. Accordingly,

$$\frac{1}{2} {( {h}^{ɛ} )}^{2} {( \frac{\partial g ( x ; t )}{\partial x} {\vert}_{x = {x}_{0}} )}^{2}$$

with respect to n ∈ [symbol] [1, N], and a fixed value by a first order combination of an integer pixel. Accordingly, the conclusion of the following equation 36 is obtained and equation 31 is proved:

$$\begin{matrix}{( {h}^{ ɛ} )}^{2} {\int }_{0}^{ 1} ( 1 - s ) \cdot \frac{ {\partial }^{2} f ( x )}{\partial {x}^{ 2}} ⅆ s = \frac{1}{2} {( {h}^{ɛ} )}^{2} \cdot \frac{{\partial }^{2} f ( x )}{\partial {x}^{2}} \\ = \frac{1}{2} {( {h}^{ɛ} )}^{2} {( \frac{\partial g ( x ; t )}{\partial x} {\vert}_{x = {x}_{0}} )}^{2}\end{matrix} \qquad ( 36 )$$

By using equation 30 to express Lipschitz continuity, it can be proved simply as the following expression 37:

$$f ( {x}_{0} + {sh}^{ɛ} ) \leq f ( {x}_{0} ) + s \cdot ( f ( {x}_{0} + {h}^{ɛ} ) - f ( {x}_{0} ) ) \\ ⇒ f ( {x}_{0} + {sh}^{ɛ} ) - f ( {x}_{0} ) \leq s \cdot ( f ( {x}_{0} + {h}^{ɛ} ) - f ( {x}_{0} ) ) \\ ⇒ ‖ f ( {x}_{0} + {sh}^{ɛ} ) - f ( {x}_{0} ) ‖ \leq ‖ s \cdot ( f ( {x}_{0} + {h}^{ɛ} ) - f ( {x}_{0} ) ) ‖ \\ ⇒ ‖ f ( {x}_{0} + {sh}^{ɛ} ) - f ( {x}_{0} ) ‖ \leq s \cdot ‖ ( f ( {x}_{0} + {h}^{ɛ} ) - f ( {x}_{0} ) ) ‖ \qquad ( 37 )$$

According to equations 30, 31, and 37, the value of the objective function with respect to an arbitrary k-th order sub-pixel can be obtained simply by expansion of a Taylor series. Accordingly, from equation 28, the following equation 38 can be obtained such that a discrete image in an n-tap FIR sub-pixel system can be generated as a continuous image:

$$f ( {x}_{0} + {h}^{ɛ} ) = f ( {x}_{0} ) + {h}^{ɛ} \cdot g ( {x}_{0} ) \cdot \frac{\partial g ( x ; t )}{\partial x} {\vert}_{x = {x}_{0}} + \frac{1}{2} {( {h}^{ɛ} )}^{2} {( \frac{\partial g ( x ; t )}{\partial x} {\vert}_{x = {x}_{0}} )}^{2} \qquad ( 38 )$$

For estimating a sub-pixel, if a sub-pixel objective function is put as the following equation 39 with respect to ∀x ∈ [symbol] ²[x−h, x+h] under conditions of equations 30, 31, and 37, the sub-pixel can be estimated with only an integer objective function value:

$$f ( x ) = \frac{1}{2} {x}^{T} Qx + {b}^{T} x + c \qquad ( 39 )$$

Here,

$$Q = [ \begin{matrix}{q}_{0}^{0} & {q}_{1}^{0} \\ {q}_{0}^{1} & {q}_{1}^{1}\end{matrix} ] .$$

The objective function of equation 39 is an objective function satisfying all equations 30, 31, and 37.

Accordingly, since according to the convex condition, objective function ƒ(x) ∈ C² satisfies a first-order necessary condition with respect to a minimum value, the following equation 40 is satisfied:
∇ƒ(x)=Qx*+b=0 x*=−Q⁻¹b (40)

According to equation 40 and the definition of matrix Q, the position of a sub-pixel minimizing an objective function is obtained as the following equation 41:

$$\begin{matrix}{x}^{*} = - {Q}^{- 1} b \\ = \frac{1}{{q}_{0}^{0} {q}_{1}^{1} - {q}_{1}^{0} {q}_{0}^{1}} [ \begin{matrix}- {q}_{1}^{1} & {q}_{1}^{0} \\ {q}_{0}^{1} & - {q}_{0}^{0}\end{matrix} ] [ \begin{matrix}{b}^{0} \\ {b}^{1}\end{matrix} ] \\ = \frac{1}{{q}_{0}^{0} {q}_{1}^{1} - {q}_{1}^{0} {q}_{0}^{1}} [ \begin{matrix}{q}_{1}^{0} {b}^{1} - {q}_{ 1}^{ 1} {b}^{ 0} \\ {q}_{0}^{1} {b}^{0} - {q}_{ 0}^{ 0} {b}^{ 1}\end{matrix} ]\end{matrix} \qquad ( 41 )$$

If matrix elements of matrix Q are put as q₁⁰=q₀¹=0, it can be regarded that only a diagonal component of the objective function is left. The eigen value and common vector of the diagonal value are (0,1) and (1,0), and it can be regarded as estimated by a conjugated quadratic function having x and y axes as principal components.

Here, in matrix Q, only estimation of the diagonal component is needed, and each component is expressed as a first-order combination of an objective function with respect to an integer pixel as the following equation 42:

$${q}_{0}^{0} = f ( {x}_{0} + h , {y}_{0} ) + f ( {x}_{0} - h , {y}_{0} ) \\ {q}_{1}^{1} = f ( {x}_{0} , {y}_{0} + h ) + f ( {x}_{0} , {y}_{0} - h ) \\ {b}_{0} = \frac{1}{2} ( f ( {x}_{0} + h , {y}_{0} ) - f ( {x}_{0} - h , {y}_{0} ) ) \\ {b}_{1} = \frac{1}{2} ( f ( {x}_{0} , {y}_{0} + h ) - f ( {x}_{0} , {y}_{0} - h ) ) \\ c = f ( {x}_{0} , {y}_{0} ) \qquad ( 42 )$$

Equations 39, 40, 41, and 43 are determined and if a center integer pixel is not a minimum value after finishing the first search of an integer pixel, the objective function is approximated to equation 42 and an integer pixel minimizing a next objective function according to equations 40 and 41 is predicted. Then, the integer pixel search can be performed more quickly as shown in FIG. 3.

The present invention can also be embodied as computer readable codes on a computer readable recording medium. The computer readable recording medium is any data storage device that can store data which can be thereafter read by a computer system. Examples of the computer readable recording medium include read-only memory (ROM), random-access memory (RAM), CD-ROMs, magnetic tapes, floppy disks, optical data storage devices, and carrier waves (such as data transmission through the Internet). The computer readable recording medium can also be distributed over network coupled computer systems so that the computer readable code is stored and executed in a distributed fashion.

While the present invention has been particularly shown and described with reference to exemplary embodiments thereof, it will be understood by those of ordinary skill in the art that various changes in form and details may be made therein without departing from the spirit and scope of the present invention as defined by the following claims. The preferred embodiments should be considered in descriptive sense only and not for purposes of limitation. Therefore, the scope of the invention is defined not by the detailed description of the invention but by the appended claims, and all differences within the scope will be construed as being included in the present invention.

According to the present invention, since an additional sub-pixel image for estimation of a sub-pixel is not needed in encoding of moving pictures, the amount of computation is greatly reduced and as a result, the computation time can also be reduced. Furthermore, a discrete image can be generated as a continuous image and at the same time, search of an integer pixel can also be performed more quickly.

What is claimed is:

1. A motion estimation method for encoding moving pictures, the method comprising:
generating an objective function for a differential definition of a sub-pixel system composed of a chain of arbitrary n-tap filters with respect to an arbitrary k-th order sub-pixel, based on the relation between an integer pixel and a sub-pixel generated through linear FIR filtering; and
estimating a motion vector of a sub-pixel by applying a conjugated quadratic algorithm to the objective function.

2. The method of claim 1, wherein the objective function is convex and continuously second-order differentiable and Lipschitz continuous.

3. The method of claim 1, wherein in the generating of the objective function, a differential in an arbitrary k-th order sub-pixel system is defined as the following equation:
$$\frac{ⅆ P ( x )}{ⅆ x} {\vert}_{x = {x}_{0}} = \frac{{2}^{k - 1} {\prod }_{m = 1}^{k - 1} {f}_{1}^{k - m}}{{h}^{0}} ( P ( {x}_{0} + h ) - P ( {x}_{0} ) )$$
where P(x) is an integer pixel and h is a unit variation of an integer pixel.

4. The method of claim 1, wherein in the generating of the objective function, an objective function for generating a sub-pixel at an arbitrary position from a predetermined integer pixel is defined as the following equation:
$$P ( {x}_{0} + {h}^{k} ) = P ( {x}_{0} ) + {h}^{k} \cdot \frac{{2}^{k - 1} {\prod }_{{h}^{0}}^{k - 1} {f}_{1}^{k - m}}{{h}^{0}} ( P ( {x}_{0} + h ) - P ( {x}_{0} ) + o ( {h}^{k} )$$
where P(x) is an integer pixel and h is a unit variation of an integer pixel.

5. The method of claim 1, wherein the estimating of the motion vector comprises estimating a sub-pixel motion vector by using a quadratic function obtained by expanding a Taylor series in relation to an objective function for generating a sub-pixel at an arbitrary position from a predetermined integer pixel.

6. The method of claim 1, wherein in the estimating of the motion vector, the quadratic function is generated based on the following equation obtained by expanding a Taylor series in relation to the objective function:
$$f ( {x}_{0} + {h}^{ɛ} ) = f ( {x}_{0} ) + {h}^{ɛ} \cdot g ( {x}_{0} ) \cdot \frac{\partial g ( x ; t )}{\partial x} {\vert}_{x = {x}_{0}} + \frac{1}{2} {( {h}^{ɛ} )}^{2} {( \frac{\partial g ( x ; t )}{\partial x} {\vert}_{x = {x}_{0}} )}^{2}$$
where P(x) is an integer pixel and h is a unit variation of an integer pixel.

7. The method of claim 1, wherein in the estimating of the motion vector, motion estimation of a sub-pixel is performed based on the following quadratic function obtained by expanding a Taylor series in relation to an objective function with respect to the arbitrary k-th order sub-pixel:
$$f ( x ) = \frac{1}{2} {x}^{T} Qx + {b}^{T} x + c , \\ where ∇ f ( x ) = {Qx}^{*} + b = 0 , \\ {x}^{*} = - {Q}^{- 1} b = \frac{1}{{q}_{0}^{0} {q}_{1}^{1} - {q}_{1}^{0} {q}_{0}^{1}} [ \begin{matrix}{q}_{1}^{0} {b}^{1} - {q}_{1}^{1} {b}^{0} \\ {q}_{0}^{1} {b}^{0} - {q}_{0}^{0} {b}^{1}\end{matrix} ] , and$$
$${q}_{0}^{0} = f ( {x}_{0} + h , {y}_{0} ) + f ( {x}_{0} - h , {y}_{0} )$$
$${q}_{1}^{1} = f ( {x}_{0} , {y}_{0} + h ) + f ( {x}_{0} , {y}_{0} - h )$$
$${b}_{0} = \frac{1}{2} ( f ( {x}_{0} + h , {y}_{0} ) - f ( {x}_{0} - h , {y}_{0} ) )$$
$${b}_{1} = \frac{1}{2} ( f ( {x}_{0} , {y}_{0} + h ) - f ( {x}_{0} , {y}_{0} - h ) )$$
$$c = f ( {x}_{0} , {y}_{0} )$$

8. A method of generating a discrete image as a continuous image, the method comprising:
generating an objective function for a differential definition of a sub-pixel system composed of a chain of arbitrary n-tap filters with respect to an arbitrary k-th order sub-pixel, based on the relation between an integer pixel and a sub-pixel generated through linear FIR filtering; and
generating a discrete image of the n-tap FIR filter sub-pixel system as a continuous image, by expanding a Taylor series in relation to the value of the objective function with respect to the arbitrary k-th order sub-pixel.
